(19) United States
(12) Patent Application Publication
(10) Pub. No.: US 2025/0271848 A1
(43) Pub. Date: Aug. 28, 2025

(54) METHOD AND SYSTEM FOR CONTROLLING MOTION OF MULTI-JOINTED BIONIC DOLPHIN AND METHOD FOR DETECTING UNDERWATER DAMAGE

(71) Applicant: Xiamen University of Technology, Xiamen (CN)

(72) Inventors: Li LIN, Xiamen (CN); Zhiqun YUAN, Xiamen (CN); Qingsong ZHENG, Xiamen (CN); Jinxiang HONG, Xiamen (CN); Yuxuan CHANG, Xiamen (CN); Chen CHEN, Xiamen (CN); Yourong ZENG, Xiamen (CN); Changtai CHEN, Xiamen (CN); Changsheng LIU, Xiamen (CN); Dandan XIA, Xiamen (CN); Xiaobo LIN, Xiamen (CN)

(21) Appl. No.: 18/589,352

(22) Filed: Feb. 27, 2024

(51) Int. Cl. G05D 1/20; G05D 105/80; G05D 107/00; G05D 109/30; G06F 30/17; G06T 7/20; G06T 17/20

(52) U.S. Cl. CPC G05D 1/20; G06F 30/17; G06T 7/20; G06T 17/205; G05D 2105/89; G05D 2107/25; G05D 2109/38

(57) ABSTRACT

A method for controlling a motion of a multi-jointed bionic dolphin relates to a technical field of damage detection using a bionic robot. The method comprises: constructing a three-dimensional model and a three-dimensional model in computational domain of the multi-jointed bionic dolphin, and performing pre-processing; importing the model file after the pre-processing into analysis software for computational fluid dynamics for the hydrodynamic simulation to obtain a thrust-time curve and a hydrodynamic curve under a specified underwater working condition, then finding a difference, and fitting to obtain velocity-resistance fitting curves; performing a kinetic analysis, and deducing a kinetic model; completing kinetic coupling to obtain kinetic parameters according to the kinetic model, the thrust-time curve, and the velocity-resistance fitting curves; and controlling output torques by a pulse width modulation (PWM) technique.

### FIELD OF THE DISCLOSURE

The present disclosure relates to a technical field of a bionic robot and damage detection of an underwater engineering structure, and in particular relates to a method and a system for controlling a motion of a multi-jointed bionic dolphin and a method for detecting underwater damage.

### BACKGROUND OF THE DISCLOSURE

Underwater robots have broad prospects for damage detection of underwater engineering structures, such as underwater structural parts of ports and bridges. However, the existing underwater robots generally use propeller propulsion. The propeller propulsion is slightly insufficient in efficiency, noise level, and maneuverability compared with bionic propulsion. The bionic propulsion, with superior motion performance thereof, is becoming a future development direction of small underwater robots. However, underwater working conditions are complex, and an application of the bionic propulsion has the two following problems: first, the bionic propulsion does not have a propeller, during work, stability of the bionic propulsion is maintained by adjusting torques of joints instead of by adjusting a working state of the propeller, and dynamic prediction of the torques of the joints is very difficult. Second, a velocity of a designed bionic robot is difficult to estimate in advance and can only be obtained by experiments. Therefore, proposing a method for dynamically predicting the torques of the joints as well as kinetic parameters, such as acceleration, velocity, displacement, etc. of the bionic robot are urgently required, so that motion of the bionic robot can be controlled to ensure stability to achieve the damage detection and localization marking of the underwater engineering structures.

### BRIEF SUMMARY OF THE DISCLOSURE

An objective of the present disclosure is to provide a method and a system for controlling a motion of a multi-jointed bionic dolphin and a method for detecting underwater damage. Torques of various joints of the multi-jointed bionic dolphin are obtained through a kinetic coupling technology, and kinetic parameters, such as acceleration, velocity, and displacement at each moment, are predicted. External influence on the multi-jointed bionic dolphin is weakened to improve a stability by controlling output torques of the various joints of the multi-jointed bionic dolphin at each moment according to the aforementioned kinetic parameters. Damage detection and localization marking of an underwater engineering structure is achieved by installing a sonar system to a head of the multi-jointed bionic dolphin using a precise motion control method.

In order to achieve the aforementioned objective, a technical solution of the present disclosure is as follows.

A method for controlling a motion of a multi-jointed bionic dolphin comprises:
Constructing a three-dimensional model and a three-dimensional model in computational domain of the multi-jointed bionic dolphin, and performing pre-processing to obtain a model file after the pre-processing; wherein the three-dimensional model is used to simulate a motion mode of the multi-jointed bionic dolphin, and the three-dimensional model in the computational domain is used for hydrodynamic simulation of the multi-jointed bionic dolphin;
Importing the model file after the pre-processing into analysis software for computational fluid dynamics for the hydrodynamic simulation to obtain a thrust-time curve and a hydrodynamic curve of the multi-jointed bionic dolphin under a specified underwater working condition, then finding a difference between the thrust-time curve and the hydrodynamic curve, and fitting to obtain velocity-resistance fitting curves of the multi-jointed bionic dolphin at various moments; wherein the specified underwater working condition mainly comprises whether there is flowing in the water domain or not and velocity and direction of water flowing;
Performing a kinetic analysis of the multi-jointed bionic dolphin, and deducing a kinetic model of the multi-jointed bionic dolphin;
Completing kinetic coupling of the multi-jointed bionic dolphin to obtain kinetic parameters of the multi-jointed bionic dolphin according to the kinetic model of the multi-jointed bionic dolphin, the thrust-time curve under the specified underwater working condition, and the velocity-resistance fitting curves of the multi-jointed bionic dolphin at the various moments; wherein the kinetic parameters comprise torques as well as accelerations, velocities, and displacements of various joints of the multi-jointed bionic dolphin at the various moments; and
Controlling output torques of the various joints of the multi-jointed bionic dolphin at each of the various moments by a pulse width modulation (PWM) technique according to the kinetic parameters of the multi-jointed bionic dolphin.

Preferably, the constructing a three-dimensional model and a three-dimensional model in computational domain of the multi-jointed bionic dolphin, and performing pre-processing to obtain a model file after the pre-processing comprises:
Constructing the three-dimensional model and the three-dimensional model in the computational domain of the multi-jointed bionic dolphin in three-dimensional drawing software; and
Importing the three-dimensional model and the three-dimensional model in the computational domain of the multi-jointed bionic dolphin into first software to perform pre-processing of model simplification and surface mesh segmentation of the three-dimensional model and the three-dimensional model in the computational domain to obtain the model file after the pre-processing.

Preferably, the importing the model file after the pre-processing into analysis software for computational fluid dynamics for the hydrodynamic simulation to obtain a thrust-time curve and a hydrodynamic curve of the multi-jointed bionic dolphin under a specified underwater working condition, then finding a difference between the thrust-time curve and the hydrodynamic curve, and fitting to obtain velocity-resistance fitting curves of the multi-jointed bionic dolphin at various moments comprises:
Importing the model file after the pre-processing into the analysis software for the computational fluid dynamics to complete construction of the computational domain, generating a body mesh, defining a boundary, and defining operation of deformation motion of the multi-jointed bionic dolphin;
Setting water velocity in the computational domain to be zero, swinging a tail of the multi-jointed bionic dolphin, and obtaining a calculated thrust-time curve by calculating to function as the thrust-time curve of the multi-jointed bionic dolphin in the specified underwater working condition when the multi-jointed bionic dolphin is swinging according to a preset kinetic equation;
Synthesizing velocities of linear motions of the multi-jointed bionic dolphin under the specified underwater working condition according to a principle of relative motion to obtain a synthesized velocity, converting the synthesized velocity into flowing of the water flowing for the hydrodynamic simulation, gradually increasing the velocity of the water flowing until a theoretical propulsion velocity of the multi-jointed bionic dolphin under thrust forces is obtained, and obtaining hydrodynamic curves of the multi-jointed bionic dolphin under the specified underwater working condition under different motion velocities in an accelerated motion; and
Finding a difference based on the thrust-time curve and the hydrodynamic curves, and fitting to obtain a resistance curve varying with velocities at the various moments to function as the velocity-resistance fitting curve of the multi-jointed bionic dolphin at the various moments when the multi-jointed bionic dolphin swings according to the preset kinetic equation.

Preferably, the performing a kinetic analysis of the multi-jointed bionic dolphin, and deducing a kinetic model of the multi-jointed bionic dolphin comprises:
Performing the kinetic analysis of the multi-jointed bionic dolphin by a Lagrangian method to centralize hydrodynamic forces, transforming the kinetic analysis of the multi-jointed bionic dolphin into a multi-rigid-body system kinetic analysis, and deducing the kinetic model of the multi-jointed bionic dolphin.

Preferably, the completing kinetic coupling of the multi-jointed bionic dolphin to obtain kinetic parameters of the multi-jointed bionic dolphin according to the kinetic model of the multi-jointed bionic dolphin, the thrust-time curve under the specified underwater working condition, and the velocity-resistance fitting curves of the multi-jointed bionic dolphin at the various moments comprises:
Constructing the kinetic model of the multi-jointed bionic dolphin in second software, and setting mass and length parameters in the kinetic model of the multi-jointed bionic dolphin;
Decomposing forces in the kinetic model into resistance forces and the thrust forces, defining corresponding thrust forces of the thrust-time curve under the specified underwater working condition as the thrust forces, obtaining the resistance forces at the various moments according to the velocity-resistance fitting curves of the multi-jointed bionic dolphin at the various moments, and subtract the resistance forces from the thrust forces to obtain combined forces of the various joints of the multi-jointed bionic dolphin at the various moments by calculating; and
Substituting the combined forces of the various joints of the multi-jointed bionic dolphin at the various moments into the kinetic model, obtaining the torques as well as the displacements, the velocities, and the accelerations of the various joints of the multi-jointed bionic dolphin at the various moments along a direction of forward movement by calculating to return to the step in which the resistance forces at the various moments are obtained according to the velocity-resistance fitting curves of the multi-jointed bionic dolphin at the various moments.

The present disclosure further provides a system for controlling a motion of a multi-jointed bionic dolphin, comprising:
A module for constructing a three-dimensional model and pre-processing, wherein the module for constructing the three-dimensional model and pre-processing is configured to construct the three-dimensional model and a three-dimensional model in a computational domain of the multi-jointed bionic dolphin and perform pre-processing to obtain a model file after the pre-processing; wherein the three-dimensional model is used to simulate a motion mode of the multi-jointed bionic dolphin, and the three-dimensional model in the computational domain is used for hydrodynamic simulation of the multi-jointed bionic dolphin;
A hydrodynamic simulation module, wherein the hydrodynamic simulation module is configured to import the model file after the pre-processing into analysis software for computational fluid dynamics for the hydrodynamic simulation to obtain a thrust-time curve and a hydrodynamic curve of the multi-jointed bionic dolphin under a specified underwater working condition, then find a difference between the thrust-time curve and the hydrodynamic curve, and fit to obtain velocity-resistance fitting curves of the multi-jointed bionic dolphin at various moments; wherein the specified underwater working condition mainly comprises whether there is flowing in a water domain or not and velocity and direction of water flowing;
A kinetic analysis module for performing a kinetic analysis of the multi-jointed bionic dolphin and deducing a kinetic model of the multi-jointed bionic dolphin;
A kinetic coupling module for completing kinetic coupling of the multi-jointed bionic dolphin obtain kinetic parameters of the multi-jointed bionic dolphin according to the kinetic model of the multi-jointed bionic dolphin, the thrust-time curve under the specified underwater working condition, and the velocity-resistance fitting curves of the multi-jointed bionic dolphin at the various moments; wherein the kinetic parameters comprise torques as well as accelerations, velocities, and displacements of the various joints of the multi-jointed bionic dolphin at the various moments; and
A dolphin motion control module for controlling output torques of the various joints of the multi-jointed bionic dolphin at each of the various moments by the pulse width modulation (PWM) technique according to the kinetic parameters of the multi-jointed bionic dolphin.

Preferably, the module for constructing the three-dimensional model and pre-processing comprises:
A three-dimensional model constructing unit configured to construct the three-dimensional model and the three-dimensional model in the computational domain of the multi-jointed bionic dolphin in three-dimensional drawing software; and
A pre-processing unit configured to import the three-dimensional model and the three-dimensional model into the computational domain of the multi-jointed bionic dolphin into first software to perform pre-processing of model simplification and surface mesh segmentation of the three-dimensional model and the three-dimensional model in the computational domain to obtain the model file after the pre-processing. Preferably, the hydrodynamic simulation module comprises:

A model file import unit configured to import the model file after the pre-processing into the analysis software for computational fluid dynamics to complete construction of the computational domain, generate a body mesh, define a boundary, and define operation of deformation motion of the multi-jointed bionic dolphin;
A thrust curve calculation unit configured to set water velocity in the computational domain to be zero, swing a tail of the multi-jointed bionic dolphin, and obtain a calculated thrust-time curve by calculating to function as the thrust-time curve of the multi-jointed bionic dolphin in the specified underwater working condition when the multi-jointed bionic dolphin is swinging according to a preset kinetic equation;
A hydrodynamic curve calculation unit configured to synthesize velocities of linear motions of the multi-jointed bionic dolphin under the specified underwater working condition according to a principle of relative motion to obtain synthesized velocity, convert the synthesized velocity into flowing of the water flowing for the hydrodynamic simulation, gradually increase a velocity of the water flowing until a theoretical propulsion velocity of the multi-jointed bionic dolphin under the thrust forces is obtained, and obtaining hydrodynamic curves of the multi-jointed bionic dolphin under the specified underwater working condition under different motion velocities in an accelerated motion; and
A velocity-resistance fitting curve calculation unit configured to find a difference based on the thrust-time curve and the hydrodynamic curves and fit to obtain a resistance curve varying with velocities at the various moments to function as the velocity-resistance fitting curve of the multi-jointed bionic dolphin at the various moments when the multi-jointed bionic dolphin swings according to the preset kinetic equation.

Preferably, the kinetic analysis module comprises:
A kinetic analysis unit configure to perform the kinetic analysis of the multi-jointed bionic dolphin by a Lagrangian method to centralize hydrodynamic forces, transform the kinetic analysis of the multi-jointed bionic dolphin into a multi-rigid-body system kinetic analysis, and deduce the kinetic model of the multi-jointed bionic dolphin.

Preferably, the kinetic coupling module specifically comprises:
A kinetic model constructing unit configured to construct the kinetic model of the multi-jointed bionic dolphin in second software and set mass and length parameters in the kinetic model of the multi-jointed bionic dolphin;
A torque calculation unit for the various joints configured to decompose forces in the kinetic model into resistance forces and the thrust forces, define corresponding thrust forces of the thrust-time curve under the specified underwater working condition as the thrust forces, obtain the resistance forces at the various moments according to the velocity-resistance fitting curves of the multi-jointed bionic dolphin at the various moments, and subtract the resistance forces from the thrust forces to obtain combined forces of various joints of the multi-jointed bionic dolphin at the various moments by calculating; and
A dolphin displacement and velocity calculation unit configured to substitute the combined force of the various joints of the multi-jointed bionic dolphin at the various moments into the kinetic model, and obtain the torques, as well as the displacements, the velocities, and the accelerations, along a direction of forward movement of the various joints of the multi-jointed bionic dolphin at the various moments by calculating to return to the step in which the resistance forces at the various moments are obtained according to the velocity-resistance fitting curve of the multi-jointed bionic dolphin at the various moments.

The present disclosure further provides a method for detecting underwater damage based on motion control of a multi-jointed bionic dolphin, comprising:
Constructing a three-dimensional model and a three-dimensional model in computational domain of the multi-jointed bionic dolphin, and performing pre-processing to obtain a model file after the pre-processing; wherein a head of the multi-jointed bionic dolphin comprises a sonar system, the three-dimensional model is used to simulate a motion mode of the multi-jointed bionic dolphin, and the three-dimensional model in the computational domain is used for hydrodynamic simulation of the multi-jointed bionic dolphin;
Importing the model file after the pre-processing into analysis software for computational fluid dynamics for the hydrodynamic simulation to obtain a thrust-time curve and a hydrodynamic curve of the multi-jointed bionic dolphin under a specified underwater working condition, then finding a difference between the thrust-time curve and the hydrodynamic curve, and fitting to obtain velocity-resistance fitting curves of the multi-jointed bionic dolphin at various moments; wherein the specified underwater working condition comprises whether there is flowing in a water domain or not and velocity and direction of the water flowing;
Performing a kinetic analysis of the multi-jointed bionic dolphin, and deducing a kinetic model of the multi-jointed bionic dolphin;
Completing kinetic coupling of the multi-jointed bionic dolphin to obtain kinetic parameters of the multi-jointed bionic dolphin according to the kinetic model of the multi-jointed bionic dolphin, the thrust-time curve under the specified underwater working condition, and the velocity-resistance fitting curves of the multi-jointed bionic dolphin at the various moments; wherein the kinetic parameters comprise torques as well as accelerations, velocities, and displacements of the various joints of the multi-jointed bionic dolphin at the various moments; and
Controlling output torques of the various joints of the multi-jointed bionic dolphin at each of the various moments by a pulse width modulation (PWM) technique according to the kinetic parameters of the multi-jointed bionic dolphin, so as to precisely control the multi-jointed bionic dolphin to perform a uniform velocity movement and resuspension localization near an underwater engineering structure being detected, and performing target identification and localization of a damaged part of the underwater engineering structure through the sonar system on the head of the multi-jointed dolphin.

The present disclosure has the following advantages based on Embodiments of the present disclosure.

The present disclosure provides a method and a system for controlling a motion of a multi-jointed bionic dolphin and a method for detecting underwater damage. The method for controlling a motion of a multi-jointed bionic dolphin comprises constructing a three-dimensional model and a three-dimensional model in computational domain of the multi-jointed bionic dolphin, and performing pre-processing to obtain a model file after the pre-processing; wherein the three-dimensional model is used to simulate a motion mode of the multi-jointed bionic dolphin, and the three-dimensional model in the computational domain is used for hydrodynamic simulation of the multi-jointed bionic dolphin; importing the model file after the pre-processing into analysis software for computational fluid dynamics for the hydrodynamic simulation to obtain a thrust-time curve and a hydrodynamic curve of the multi-jointed bionic dolphin under a specified underwater working condition and velocity-resistance fitting curves of the multi-jointed bionic dolphin at various moments; performing a kinetic analysis of the multi-jointed bionic dolphin, and deducing a kinetic model of the multi-jointed bionic dolphin; completing kinetic coupling of the multi-jointed bionic dolphin to obtain kinetic parameters of the multi-jointed bionic dolphin according to the kinetic model of the multi-jointed bionic dolphin, the thrust-time curve under the specified underwater working condition, and the velocity-resistance fitting curves of the multi-jointed bionic dolphin at the various moments; wherein the kinetic parameters comprise torques as well as accelerations, velocities, and displacements of various joints of the multi-jointed bionic dolphin at the various moments; and controlling output torques of the various joints of the multi-jointed bionic dolphin at each of the various moments by a pulse width modulation (PWM) technique according to the kinetic parameters of the multi-jointed bionic dolphin. The method of the present disclosure obtains the torques of the various joints of the multi-jointed bionic dolphin by a kinetic coupling technique. Kinetic parameters, such as acceleration, velocity, and displacement, at each moment, are predicted, and output torques of the various joints of the multi-jointed bionic dolphin at each moment are controlled according to the aforementioned kinetic parameters. External influence on the multi-jointed bionic dolphin is weakened, and a stability is improved.

Further, the present disclosure can also achieve damage detection and localization marking of an underwater engineering structure by a method for precise motion control of the multi-jointed bionic dolphin by installing a sonar system to a head of the multi-jointed bionic dolphin.

### BRIEF DESCRIPTION OF THE DRAWINGS

The accompanying drawings used in the embodiments will be briefly introduced below to more clearly describe the technical solutions in the embodiments of the present disclosure or the existing techniques. It will be obvious that the accompanying drawings in the following description are merely some embodiments of the present disclosure, and other drawings can be obtained based on the accompanying drawings by person of skill in the art without creative work.

FIG. 1 shows a flowchart of a method for controlling a motion of a multi-jointed bionic dolphin of the present disclosure;

FIG. 2 shows a diagram of a thrust-time curve of an embodiment of the present disclosure;

FIGS. 3a, 3b, 3c, 3d, 3e, and 3f show diagrams of hydrodynamic curves under a static water working condition in the embodiment of the present disclosure, wherein FIGS. 3a, 3b, 3c, 3d, 3e, and 3f correspond to the diagrams of the hydrodynamic curves of the multi-jointed bionic dolphin moving under the static water working condition at a velocity of 0.2 meters/second (m/s), 0.6 m/s, 1 m/s, 1.4 m/s, 1.8 m/s, and 2.2 m/s, respectively;

FIG. 4 shows a diagram of a velocity-resistance fitting curve under the static water working condition in the embodiment of the present disclosure;

FIG. 5 shows a diagram of a kinetic analysis process of the present disclosure;

FIG. 6 shows a diagram of a kinetic model constructed in Matlab& software of the present disclosure;

FIG. 7 shows a diagram of a process of a kinetic coupling technique of the present disclosure;

FIGS. 8a and 8b show graphs of kinetic parameters of the embodiment of the present disclosure. FIG. 8a shows a graph of a torque-time curve, and FIG. 8b shows a graph of various kinetic parameters (such as acceleration, velocity, and displacement)-time curve; and

FIG. 9 shows a flowchart of a method for detecting underwater damage based on motion control of the multi-jointed bionic dolphin of the present disclosure.

### DETAILED DESCRIPTION OF THE EMBODIMENTS

The technical solutions in the embodiments of the present disclosure will be clearly and completely described below in combination with the accompanying drawings in the embodiments of the present disclosure. It is obvious that the described embodiments are merely a part of the embodiments of the present disclosure instead of all of the embodiments. It is intended that a protection scope of the present disclosure cover all other embodiments provided they are made based on the embodiments of the present disclosure by a person of ordinary skill in the art without creative works.

An objective of the present disclosure is to provide a method for controlling motion of a multi-jointed bionic dolphin, a system thereof, and a method for detecting underwater damage. Torques of various joints of the multi-jointed bionic dolphin can be obtained by a kinetic coupling technique, and acceleration thereof, velocity thereof, and displacement parameters thereof at each moment can be predicted to control output torques of the various joints of the multi-jointed bionic dolphin at each moment based on the aforementioned kinetic parameters. External influence on the multi-jointed bionic dolphin is weakened, and a stability thereof is improved. Damage detection damage detection and localization marking of underwater engineering structures is achieved by installing a sonar system in a head of the multi-jointed bionic dolphin by a method for precise motion control.

The present disclosure will be further described below in combination with the accompanying drawings and embodiments to enable the aforementioned objectives, features, and advantages of the present disclosure to be more obvious and easily understood.

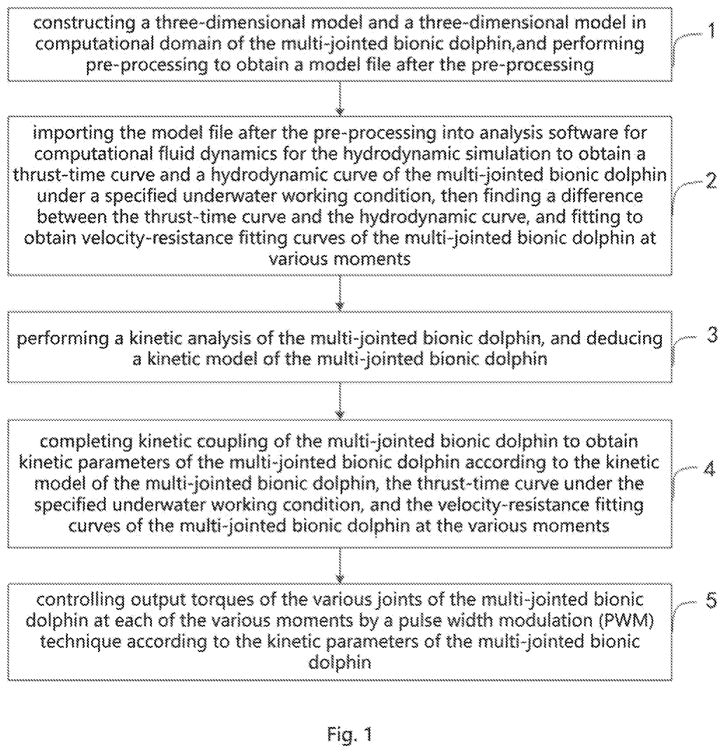

FIG. 1 shows a flowchart of a method for controlling a motion of a multi-jointed bionic dolphin of the present disclosure. Referring to FIG. 1, the method for controlling the motion of the multi-jointed bionic dolphin of the present disclosure specifically comprises:

Step 1: constructing a three-dimensional model and a three-dimensional model in a computational domain of the multi-jointed bionic dolphin, and performing pre-processing to obtain a model file after the pre-processing. The three-dimensional model is used to simulate a motion mode of the multi-jointed bionic dolphin, and the three-dimensional model in the computational domain is used for hydrodynamic simulation of the multi-jointed bionic dolphin.

Specifically, the three-dimensional model and the three-dimensional model in the computational domain of the multi-jointed bionic dolphin are constructed in SolidWorks® three-dimensional drawing software. The three-dimensional model and the three-dimensional model in the computational domain of the multi-jointed bionic dolphin are imported into Hypermesh® software to perform pre-processing of model simplification and surface mesh segmentation of the three-dimensional model and the three-dimensional model in the computational domain to obtain the model file after the pre-processing.

Step 2: importing the model file after the pre-processing into analysis software for computational fluid dynamics for the hydrodynamic simulation to obtain a thrust-time curve and a hydrodynamic curve of the multi-jointed bionic dolphin under a specified underwater working condition, then finding a difference between the thrust-time curve and the hydrodynamic curve, and fitting to obtain velocity-resistance fitting curves of the multi-jointed bionic dolphin at various moments. The specified underwater working condition mainly comprises whether there is water flowing in a water domain or not and velocity and direction of water.

Specifically, the model file after the pre-processing is imported into analysis software for Star-CCM+® computational fluid dynamics to complete construction of the computational domain, a body mesh is generated, a boundary is defined, and operation of deformation motion of the multi-jointed bionic dolphin is defined. Water velocity in the computational domain is set to be zero, a tail of the multi-jointed bionic dolphin swings, and a calculated thrust-time curve is obtained by calculating to function as the thrust-time curve of the multi-jointed bionic dolphin in the specified underwater working condition when the multi-jointed bionic dolphin is swinging according to a preset kinetic equation. According to a principle of relative motion, velocities of linear motions of the multi-jointed bionic dolphin under the specified underwater working condition are synthesized to obtain a synthesized velocity, the synthesized velocity is converted into flowing of the water flowing for the hydrodynamic simulation, a velocity of the water flowing is gradually increased until a theoretical propulsion velocity of the multi-jointed bionic dolphin under the thrust forces is obtained, and the hydrodynamic curves of the multi-jointed bionic dolphin under the specified underwater working condition under different motion velocities in an accelerated motion are obtained. A difference is found based on the previously obtained thrust-time curve and the hydrodynamic curves and fitted to obtain a resistance curve varying with velocities at the various moments to function as the velocity-resistance fitting curve of the multi-jointed bionic dolphin at the various moments when the multi-jointed bionic dolphin swings according to the preset kinetic equation.

Step 3: performing a kinetic analysis of the multi-jointed bionic dolphin, and deducing a kinetic model of the multi-jointed bionic dolphin.

Specifically, the kinetic analysis of the multi-jointed bionic dolphin is performed by a Lagrangian method to centralize hydrodynamic forces. The kinetic analysis of the multi-jointed bionic dolphin is transformed into a multi-rigid-body system kinetic analysis, and the kinetic model of the multi-jointed bionic dolphin is deduced.

Step 4: completing kinetic coupling of the multi-jointed bionic dolphin to obtain kinetic parameters of the multi-jointed bionic dolphin according to the kinetic model of the multi-jointed bionic dolphin, the thrust-time curve under the specified underwater working condition, and the velocity-resistance fitting curves of the multi-jointed bionic dolphin at the various moments.

Specifically, the kinetic model of the multi-jointed bionic dolphin is constructed in the Matlab® software, and mass and length parameters in the kinetic model of the multi-jointed bionic dolphin are set. Forces in the kinetic model are decomposed into resistance forces and the thrust forces, and corresponding thrust forces of the thrust-time curve under the specified underwater working condition are defined as the thrust forces. The resistance forces at the various moments are obtained according to the velocity-resistance fitting curves of the multi-jointed bionic dolphin at the various moments, and the resistance forces are subtracted from the thrust forces to obtain combined forces of the various joints of the multi-jointed bionic dolphin at the various moments by calculating. The combined force of the various joints of the multi-jointed bionic dolphin at the various moments are substituted into the kinetic model. The torques, as well as the displacements, the velocities, and the accelerations, of the various joints of the multi-jointed bionic dolphin at the various moments along a direction of forward movement are obtained by calculating to return to the step in which the resistance forces at the various moments are obtained according to the velocity-resistance fitting curves of the multi-jointed bionic dolphin at the various moments.

Step 5: controlling the output torques of the various joints of the multi-jointed bionic dolphin at each of the various moments by a pulse width modulation (PWM) technique according to the kinetic parameters of the multi-jointed bionic dolphin.

Specifically, a control strategy is written using the PWM technique based on the kinetic parameters obtained by the simulation. Average power transmitted by electrical signals is adjusted by dispersing effective electrical signals into discrete forms, i.e., the output torques of the various joints of the multi-jointed bionic dolphin at each of the various moments can be controlled, so as to weaken external influence on the multi-jointed bionic dolphin to improve stability.

The method of the present disclosure can improve the stability of the multi-jointed bionic dolphin during work, the kinetic parameters of the multi-jointed bionic dolphin can be predicted by the method, and the torques corresponding to the various joints of the multi-jointed bionic dolphin during work at each of the various moments can be obtained. The average power transmitted by the electrical signals are adjusted by dispersing the effective electrical signals into the discrete forms by the PWM technique, i.e., the output torques of the various joints at each of the various moments can be controlled, so as to weaken the external influence on the multi-jointed bionic dolphin to improve the stability. Moreover, when the multi-jointed bionic dolphin moves according to a certain kinetic equation, parameters, such as the accelerations, the velocities, and the displacements at each of the various moments can be predicted by the method of the present disclosure. With respect to a specified multi-jointed bionic dolphin, i.e., determined parameters, such as mass, length, volume, etc., and a maximum velocity of the forward movement and a corresponding kinetic equation thereof can be further obtained by the method of the present disclosure.

### Embodiment 1

As an example, a two-jointed bionic dolphin moving in static water described below provides a specific embodiment of the method for controlling a motion of a multi-jointed bionic dolphin of the present disclosure. The embodiment of the method specifically comprises the following steps:

Step 1: establishing a three-dimensional model and a three-dimensional model in a computational domain of a two-jointed bionic dolphin and performing pre-processing to obtain a model file after the pre-processing.

Specifically, the three-dimensional model and the three-dimensional model in the computational domain of the two-jointed bionic dolphin (dolphin for short) are created in the SolidWorks& three-dimensional drawing software; wherein the three-dimensional model is used to simulate a motion mode of the two-jointed bionic dolphin, and the three-dimensional model in the computational domain is used for hydrodynamic simulation of the two-jointed bionic dolphin. The three-dimensional model and the three-dimensional model in the computational domain of the two-jointed bionic dolphin are imported into the Hypermesh software to perform pre-processing of model simplification and surface mesh segmentation of the three-dimensional model and the three-dimensional model in the computational domain to obtain the model file after the pre-processing.

Step 2: importing the model file after the pre-processing into analysis software for computational fluid dynamics for the hydrodynamic simulation to obtain a thrust-time curve, a hydrodynamic curve, and velocity-resistance fitting curves of the two-jointed bionic dolphin at various moments in the static water working condition.

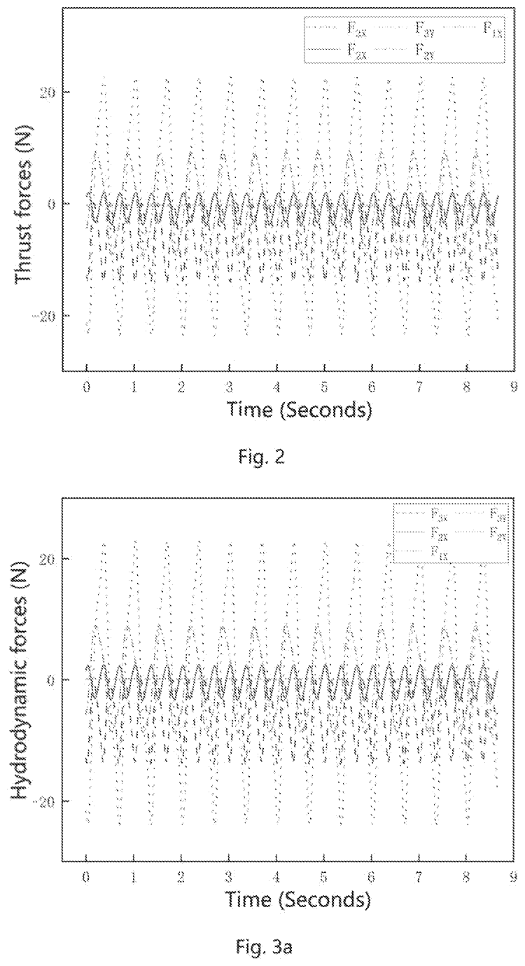

The model file after the pre-processing is imported into the Star-CCM+® analysis software for the computational fluid dynamics to complete construction of the computational domain, a body mesh is generated, a boundary is defined, and operation, such as deformation motion of the multi-jointed bionic dolphin, is defined. A velocity of the water flowing in the computational domain is set to be 0 meters/second (m/s), a tail of the two-jointed bionic dolphin swings according to preset θ₂₁(t) and θ₃₂(t) equations, and a calculated thrust-time curve is calculated to function as the thrust-time curve in the static water working condition when the two-jointed bionic dolphin is swinging according to the preset kinetic equation, as shown in FIG. 2. At this time, hydrodynamic force is pure thrust forces, and the thrust-time curve (thrust data) is exported to an intermediate file form.

θ₂₁(t)=0.3878 sin(3πt)

$${θ}_{32} ( t ) = - 0.5824 sin ( 3 π t + π / 2 )$$

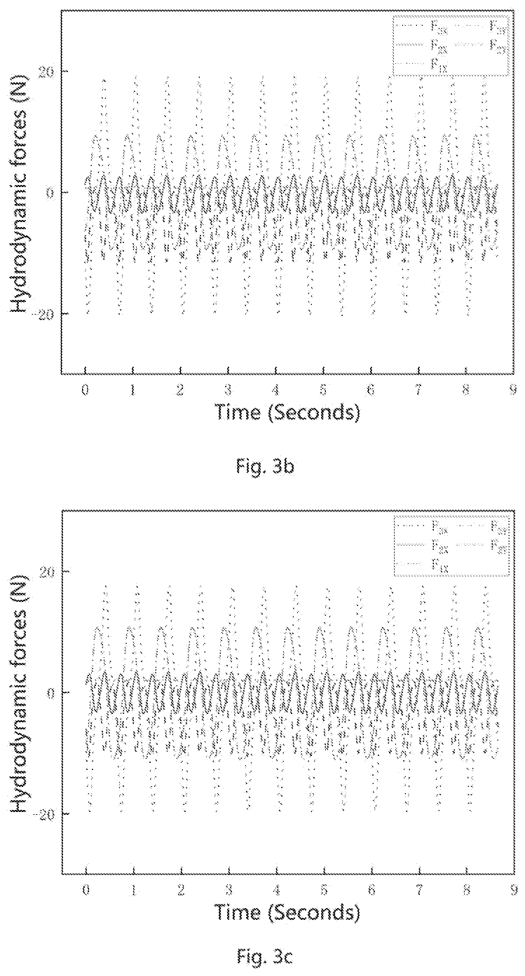

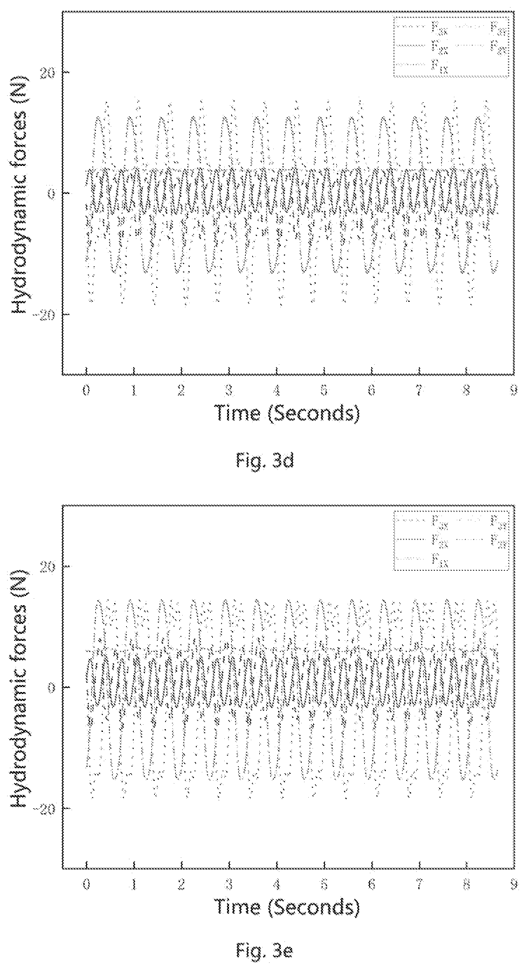

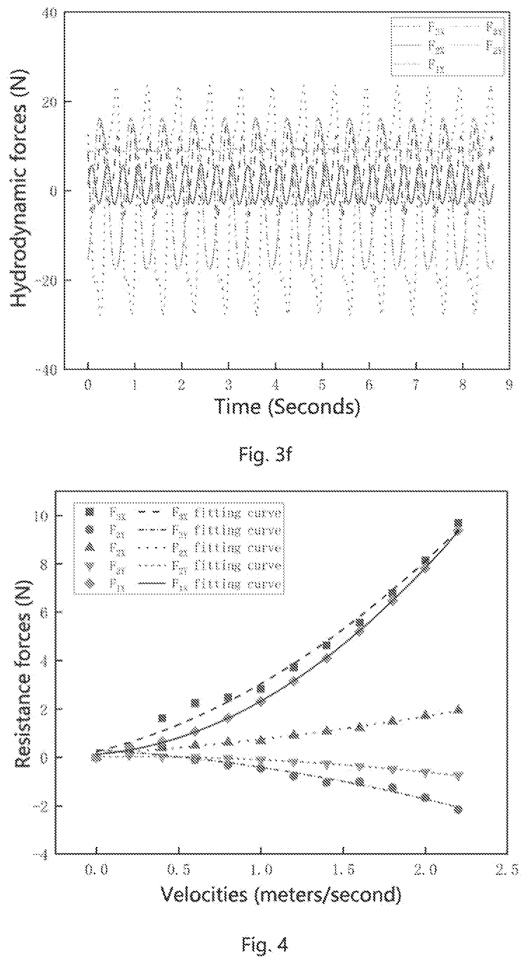

Further, according to the principle of relative motion, velocities of linear motions of the two-jointed bionic dolphin under the thrust forces are converted into a velocity of the water flowing for the hydrodynamic simulation, the velocity of the water flowing gradually increases until a theoretical propulsion velocity of the two-jointed bionic dolphin under the thrust forces is obtained, and hydrodynamic numerical curves (i.e., the hydrodynamic curves) under different motion velocities in an accelerated motion are obtained when the two-jointed bionic dolphin is swinging according to a specified kinetic equation, as shown in FIGS. 3a, 3b, 3c, 3d, 3e, and 3f. At this time, the hydrodynamic force is a magnitude of combined force, i.e., the resistance force is subtracted from the thrust forces.

Further, a difference is found based on the previously obtained thrust-time curve and the hydrodynamic curves and fitted to obtain a resistance curve varying with velocities at the various moments to function as the velocity-resistance force fitting curve of the two-jointed bionic dolphin at the various moments when the two-jointed bionic dolphin swings according to a preset kinetic equation, as shown in FIG. 4. In FIG. 4, the abscissa is a velocity v, and the ordinate is a resistance force F. An equation of the velocity-resistance force fitting curve at the various moments in FIG. 3 is shown in Table 1.

TABLE 1
The equation of the velocity-resistance force fitting curve

| Force | The equation of the fitting curve |
|---|---|
| F_{3X} | F = 0.985v² + 2.0826v |
| F_{2X} | F = 0.2045v³ − 0.5431v² + 1.1133v |
| F_{1X} | F = 1.5748 v² + 0.7634 v |
| F_{3Y} | F = −1.1334v⁴ + 5.1789v³ − 7.8228v² + 3.2164v |
| F_{2Y} | F = −0.2117v² + 0.1214v |

Step 3: The kinetic analysis of the two-jointed bionic dolphin is performed, and the kinetic model of the two-jointed bionic dolphin is deduced.

The kinetic analysis of the two-jointed bionic dolphin is performed by the Lagrangian method, hydrodynamic force is centralized, the kinetic analysis of the two-jointed bionic dolphin is transformed into the kinetic analysis of the multi-rigid-body system kinetic analysis, and the kinetic model of the two-jointed bionic dolphin is deduced.

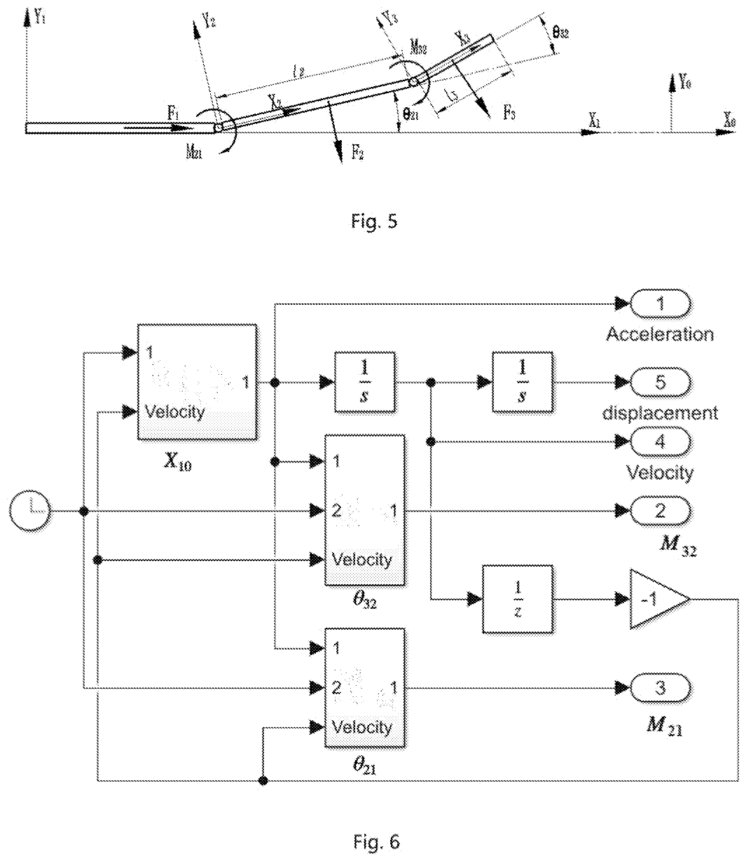

FIG. 5 shows a diagram of a kinetic analysis process of the present disclosure. In FIG. 5, X₀Y₀ is the Earth's Coordinate System, and X₁Y₁, X₂Y₂, and X₃Y₃ are coordinate systems respectively based on a body, a caudal peduncle, and a caudal fin of the two-jointed bionic dolphin. As shown in FIG. 4, the following assumptions are proposed for simplifying a process:
a. Various parts of the two-jointed bionic dolphin are simplified as a rod with uniform mass distribution, a mass center is considered as a geometric center, and the two-jointed bionic dolphin is considered as a rigid body;
b. Variations in a gravity center and a center of buoyancy caused by swinging of the caudal peduncle and the caudal fin are not considered;
c. Merely a forward working condition of the two-jointed bionic dolphin is considered, and merely displacement of the two-jointed bionic dolphin in an x-direction will be produced.

The two-jointed bionic dolphin has three degrees of freedom in this condition, and a relationship of the various joints is described by a transformation of the coordinate systems. F₁, F₂, and F₃ are respectively the hydrodynamic force on the body, the caudal peduncle, and the caudal fin of the two-jointed bionic dolphin and are integrated in mass centers of various parts. M₂₁ and M₃₂ are torques of joints of the various parts of the two-jointed bionic dolphin, wherein M₂₁ is a torque of a joint between the body and the caudal peduncle of the two-jointed bionic dolphin, and M₃₂ is a torque of a joint between the caudal peduncle and the caudal fin of the two-jointed bionic dolphin. I₂ and I₃ are respectively lengths of the caudal fin and the caudal peduncle. m₁, m₂, and m₃ are respectively masses of the body, the caudal peduncle, and the caudal fin of the two-jointed bionic dolphin. The kinetic analysis is performed by the Lagrangian method, and finally obtained results are collated into a matrix form:

$$A [ \begin{matrix}{\ddot{θ}}_{21} \\ {\ddot{θ}}_{32} \\ {\ddot{X}}_{10}\end{matrix} ] + B [ \begin{matrix}{{\dot{θ}}_{21}}^{2} \\ {{\dot{θ}}_{32}}^{2} \\ {{\dot{X}}_{10}}^{2}\end{matrix} ] + C [ \begin{matrix}{\dot{θ}}_{21} {\dot{X}}_{10} \\ {\dot{θ}}_{32} {\dot{X}}_{10} \\ {\dot{θ}}_{21} {\dot{θ}}_{32}\end{matrix} ] + D = E , wherein$$

$$A = [ \begin{matrix}\frac{1}{3} {m}_{2} {{l}_{2}}^{2} + \frac{1}{4} {m}_{3} {{l}_{3}}^{2} + & \frac{1}{4} {m}_{3} {{l}_{3}}^{2} + \frac{1}{2} {m}_{3} {l}_{2} {l}_{3} cos {θ}_{32} & - \frac{1}{2} {m}_{2} {l}_{2} sin {θ}_{21} + {m}_{3} {l}_{2} sin {θ}_{21} - \\ {m}_{3} {{l}_{2}}^{2} + {m}_{3} {l}_{2} {l}_{3} cos {θ}_{32} & & \frac{1}{2} {m}_{3} {l}_{3} sin ( {θ}_{21} + {θ}_{32} ) \\ \frac{1}{4} {m}_{3} {{l}_{3}}^{2} + \frac{1}{2} {m}_{3} {l}_{2} {l}_{3} cos {θ}_{32} & \frac{1}{3} {m}_{3} {{l}_{3}}^{2} & - \frac{1}{2} {m}_{3} {l}_{3} sin ( {θ}_{21} + {θ}_{32} ) \\ - \frac{1}{2} {m}_{2} {l}_{2} sin {θ}_{21} - {m}_{3} {l}_{2} sin {θ}_{21} - & - \frac{1}{2} {m}_{3} {l}_{3} sin ( {θ}_{21} + {θ}_{32} ) & {m}_{1} + {m}_{2} + {m}_{3} \\ \frac{1}{2} {m}_{3} {l}_{3} sin ( {θ}_{21} + {θ}_{32} ) & & \end{matrix} ]$$

$$B = [ \begin{matrix}0 & - \frac{1}{2} {m}_{3} {l}_{2} {l}_{3} sin {θ}_{32} & 0 \\ \frac{1}{2} {m}_{3} {l}_{2} {l}_{3} & 0 & 0 \\ - \frac{1}{2} {m}_{2} {l}_{2} cos {θ}_{21} - {m}_{3} {l}_{2} cos {θ}_{21} - & - \frac{1}{2} {m}_{3} {l}_{3} cos ( {θ}_{21} + {θ}_{32} ) & 0 \\ \frac{1}{2} {m}_{3} {l}_{3} cos ( {θ}_{21} + {θ}_{32} ) ] & & \end{matrix} ]$$

$$C = [ \begin{matrix}0 & 0 & 0 \\ 0 & 0 & 0 \\ 0 & 0 & - {m}_{3} {l}_{3} cos ( {θ}_{21} + {θ}_{32} )\end{matrix} ]$$

$$D = [ \begin{matrix}\frac{1}{2} {m}_{2} {gl}_{2} cos {θ}_{21} + {m}_{3} {gl}_{2} cos {θ}_{21} \\ \frac{1}{2} {m}_{3} {gl}_{3} cos {θ}_{32} \\ 0\end{matrix} ]$$

$$E = [ \begin{matrix}- \frac{1}{2} {l}_{2} sin {θ}_{21} {F}_{2 x} + \frac{1}{2} {l}_{2} cos {θ}_{21} {F}_{2 y} - {l}_{2} sin {θ}_{21} {F}_{3 x} - \\ \frac{1}{2} {l}_{3} sin ( {θ}_{21} + {θ}_{32} ) {F}_{3 x} + {l}_{2} cos {θ}_{21} {F}_{3 y} + \frac{1}{2} {l}_{3} cos ( {θ}_{21} + {θ}_{32} ) {F}_{3 y} + {M}_{21} \\ - \frac{1}{2} {l}_{3} sin {θ}_{32} {F}_{3 x} + \frac{1}{2} {l}_{3} cos {θ}_{32} {F}_{3 y} + {M}_{32} \\ {F}_{1 x} + {F}_{2 x} + {F}_{3 x}\end{matrix} ]$$

The matrix (1) is the kinetic model obtained by deducing, and θ₂₁ and θ₃₂ respectively represents oscillating functions of the caudal peduncle and the caudal fin of the two-jointed bionic dolphin. X₁₀ represents a displacement of the two-jointed bionic dolphin in an X₀ direction. F₁ₓ is force on the body of the two-jointed bionic dolphin in the X₀ direction. F₂ₓ and F_{2y} are respectively projections of F₂ on an X₀ axis and a Y₀ axis of the X₀Y₀ coordinate system. F₃ₓ and F_{3y} are respectively projections of F₃ on the X₀ axis and the Y₀ axis of the X₀Y₀ coordinate system.

When given θ₂₁(t) and θ₃₂(t) situation of the kinetic model, M₂₁(t), M₃₂(t), and X₁₀(t) can be obtained. That is, when given the oscillating function θ₂₁(t) and θ₃₂(t) of the caudal peduncle and the caudal fin at a moment t, a displacement function X₁₀(t) and resistance torques M₂₁(t) and M₃₂(t) of the caudal peduncle and the caudal fin of the two-jointed bionic dolphin in the X₀ direction at the moment/are obtained by calculating. The kinetic model can also be used to reversely solve the problem, i.e., when given M₂₁(t) and M₃₂(t), θ₂₁(t), θ₃₂(t), and X₁₀(t) can be reversely deduced.

Step 4: According to the kinetic model, the thrust-time curve under the static water working condition, and the velocity-resistance fitting curves of the two-jointed bionic dolphin at the various moments of the two-jointed bionic dolphin, the kinetic coupling of the two-jointed bionic dolphin is completed, and the kinetic parameters of the two-jointed bionic dolphin are obtained. The kinetic parameters comprise torques as well as accelerations, velocities, and displacements of the various joints of the two-jointed bionic dolphin at the various moments.

The kinetic model of the two-jointed bionic dolphin is constructed in the Matlab® software, as shown in FIG. 6, 1/s functions as an integrator in the Matlab® software for an integral operation. Integration of the accelerations is velocities, and integration of the velocities is the displacements. 1/z is a delay module of the Matlab® software, and the delay module is used to record data of a previous time step to be used in this time step and is used to record a velocity obtained in the previous time step in the kinetic model of the present disclosure. In FIG. 6, three parameters, X₁₀, θ₂₁, and θ₃₂, below the corresponding module are defined as generalized coordinates in the Lagrangian method.

The parameters, such as mass and length, of the two-jointed bionic dolphin are set up in the kinetic model of the Matlab® software.

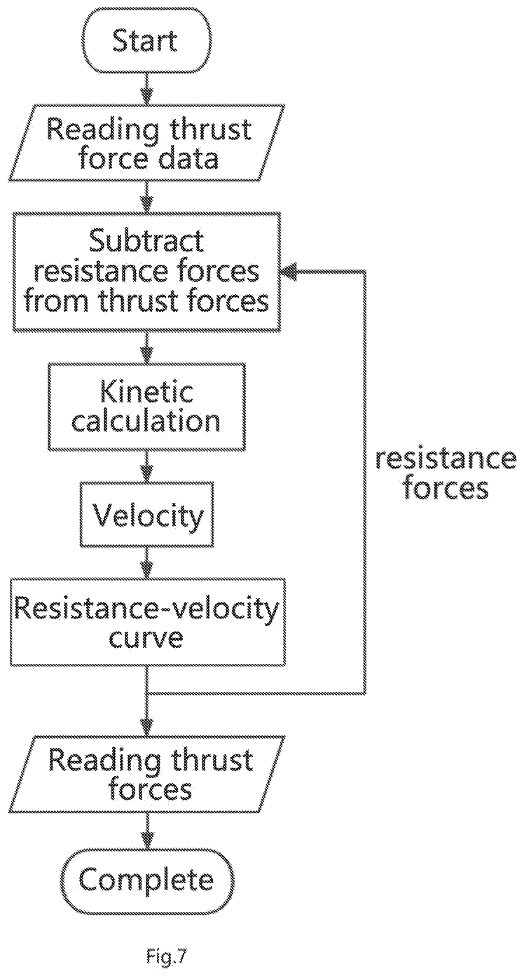

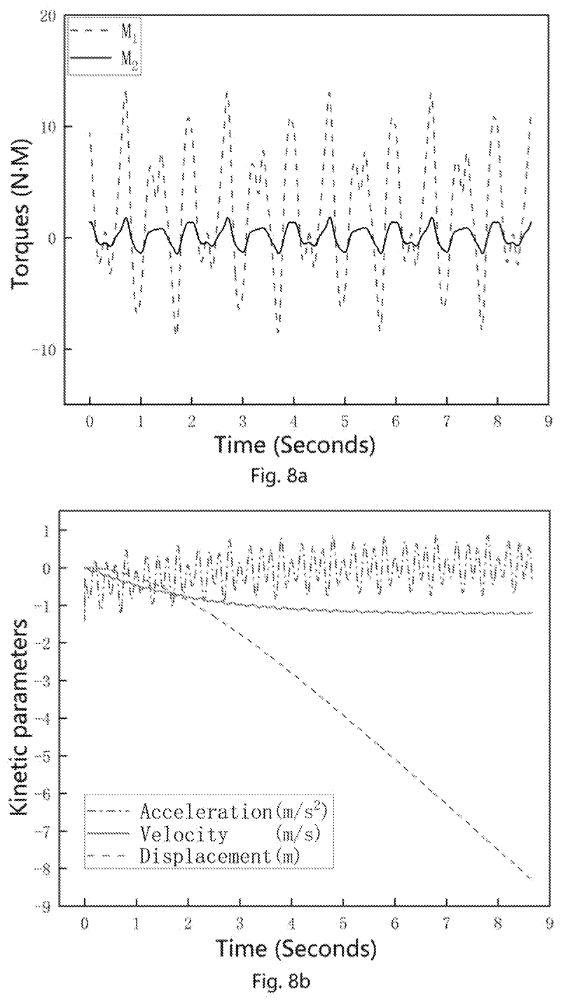

Forces in the kinetic model are decomposed into resistance forces and the thrust forces, and corresponding thrust forces of the thrust-time curve under the static water working condition (i.e., a hydrokinetic curve when a water velocity is 0 m/s) are defined as the thrust forces. Further, data of the thrust forces of the first time step in the intermediate file is read by the Matlab® software. At this time, a velocity of the two-jointed bionic dolphin is 0 m/s, and the resistance force is 0. The resistance forces are subtracted from the thrust forces to obtain combined forces of the various joints of the two-jointed bionic dolphin at the first time step by calculating, and F₁ₓ, F₂ₓ, F₃ₓ, F_{2y}, and F_{3y} in the kinetic model are therefore obtained. The combined forces at the first time step are subsequently substituted into the kinetic model for kinetic calculations, and corresponding torques, corresponding displacements, corresponding velocities, and corresponding accelerations of the various joints of the two-jointed bionic dolphin at the first time step are obtained by calculating. Further, the velocities are used as an initial condition for a next simulation of the kinetic model, and the velocities are substituted into the velocity-resistance fitting curves to obtain magnitudes of next resistance forces by calculating. Further, thrust data of a second time step are read from an intermediate file by the Matlab software. At this time, combined forces (hydrodynamic forces) are read data from which resistance forces calculated in the previous step are subtracted, and a velocity corresponding to the second time step is then obtained by the simulation of the kinetic model. A unidirectional kinetic coupling of the two-jointed bionic dolphin is completed by repeating the aforementioned steps, as shown in FIG. 7. Finally, dynamic images of the torques and the kinetic parameters, such as the accelerations, the velocities, and the displacements, of the various joints of the two-jointed bionic dolphin under the various working conditions are obtained, as shown in FIGS. 8a and 8b.

The torques of the various joints of the two-jointed bionic dolphin under the various working conditions can be obtained by the aforementioned kinetic coupling, the control strategy is written by the PWM technique, and external influence on the two-jointed bionic dolphin during work are weakened to improve stability. When the various joints of the two-jointed bionic dolphin move in a certain state, the parameters, such as the accelerations, the velocities, the displacements, and so on, at each of the various moment can be predicted by kinetic coupling. With respect to a certain specified two-jointed bionic dolphin, i.e., parameters, such as determined mass, determined length, determined volume, etc., a maximum movement velocity and corresponding kinetic equations of the certain specified two-jointed bionic dolphin can also be obtained by the method of the present disclosure.

Step 5: the output torques of the various joints of the two-jointed bionic dolphin at each of the various moment are controlled using the PWM technique based on the kinetic parameters of the two-jointed bionic dolphin.

The control strategy is written using the PWM technique based on the kinetic parameters obtained by the simulation, and an average power transmitted by electrical signals is adjusted by dispersing effective electrical signals into the discrete forms, i.e., the output moments of the joints of the two-jointed bionic dolphin at each of the various moment can be controlled, so as to weaken external influence on the two-jointed bionic dolphin to improve the stability.

Based on the method of the present disclosure, the present disclosure also provides a system for controlling the motion of the multi-jointed bionic dolphin, the system comprises:
A module for constructing a three-dimensional model and pre-processing, wherein the module for constructing the three-dimensional model and pre-processing is configured to construct the three-dimensional model and a three-dimensional model in computational domain of the multi-jointed bionic dolphin and perform pre-processing to obtain a model file after the pre-processing; wherein the three-dimensional model is used to simulate a motion mode of the multi-jointed bionic dolphin, and the three-dimensional model in the computational domain is used for hydrodynamic simulation of the multi-jointed bionic dolphin;
A hydrodynamic simulation module, wherein the hydrodynamic simulation module is configured to import the model file after the pre-processing into analysis software for computational fluid dynamics for the hydrodynamic simulation to obtain a thrust-time curve and a hydrodynamic curve of the multi-jointed bionic dolphin under a specified underwater working condition, then find a difference between the thrust-time curve and the hydrodynamic curve, and fit to obtain velocity-resistance fitting curves of the multi-jointed bionic dolphin at various moments; wherein the specified underwater working condition mainly comprises whether there is flowing in the water domain or not and velocity and direction of water flowing;
A kinetic analysis module for performing a kinetic analysis of the multi-jointed bionic dolphin and deducing a kinetic model of the multi-jointed bionic dolphin;
A kinetic coupling module for completing kinetic coupling of the multi-jointed bionic dolphin to obtain the kinetic parameters of the multi-jointed bionic dolphin according to the kinetic model of the multi-jointed bionic dolphin, the thrust-time curve under the specified underwater working condition, and the velocity-resistance fitting curves of the multi-jointed bionic dolphin at the various moments; wherein the kinetic parameters comprise torques as well as accelerations, velocities, and displacements of the various joints of the multi-jointed bionic dolphin at various moments;
A dolphin motion control module for controlling the output torques of the various joints of the multi-jointed bionic dolphin at each of the various moments by the PWM technique according to the kinetic parameters of the multi-jointed bionic dolphin.

The module for constructing the three-dimensional model and pre-processing specifically comprises:
A three-dimensional model constructing unit configured to construct the three-dimensional model and the three-dimensional model in the computational domain of the multi-jointed bionic dolphin in the SolidWorks® three-dimensional drawing software; and
A pre-processing unit configured to import the three-dimensional model and the three-dimensional model in the computational domain of the multi-jointed bionic dolphin into the Hypermesh® software to perform pre-processing of model simplification and surface mesh segmentation of the three-dimensional model and the three-dimensional model in the computational domain to obtain the model file after the pre-processing.

The hydrodynamic simulation module specifically comprises:
A model file import unit configured to import the model file after the pre-processing into the analysis software for the Star-CCM+® computational fluid dynamics to complete construction of the computational domain, generate a body mesh, define a boundary, and define operation of deformation motion of the multi-jointed bionic dolphin;
A thrust curve calculation unit configured to set water velocity in the computational domain to be zero, swing a tail of the multi-jointed bionic dolphin, and obtain a calculated thrust-time curve by calculating to function as the thrust-time curve of the multi-jointed bionic dolphin in the specified underwater working condition when the multi-jointed bionic dolphin is swinging according to a preset kinetic equation;
A hydrodynamic curve calculation unit configured to synthesize velocities of linear motions of the multi-jointed bionic dolphin under the specified underwater working condition according to the principle of relative motion, convert the synthesized velocity into flowing of the water flowing for the hydrodynamic simulation, gradually increase a velocity of the water flowing until a theoretical propulsion velocity of the multi-jointed bionic dolphin under the thrust forces is obtained, and obtain the hydrodynamic curves of the multi-jointed bionic dolphin under the specified underwater working condition under different motion velocities in an accelerated motion; and
A velocity-resistance fitting curve calculation unit configured to find a difference based on the thrust-time curve and the hydrodynamic curves and fit to obtain a resistance curve varying with velocities at the various moments to function as the velocity-resistance fitting curve of the multi-jointed bionic dolphin at the various moments when the multi-jointed bionic dolphin swings according to the preset kinetic equation.

The kinetic analysis module specifically comprises:
A kinetic analysis unit configure to perform the kinetic analysis of the multi-jointed bionic dolphin by a Lagrangian method to centralize hydrodynamic forces, transform the kinetic analysis of the multi-jointed bionic dolphin into a multi-rigid-body system kinetic analysis, and deduce the kinetic model of the multi-jointed bionic dolphin.

The kinetic coupling module specifically comprises:

A kinetic model constructing unit configured to construct the kinetic model of the multi-jointed bionic dolphin in the Matlab® software and set mass and length parameters in the kinetic model of the multi-jointed bionic dolphin.

A torque calculation unit for the various joints configured to decompose forces in the kinetic model into resistance forces and the thrust forces, define corresponding thrust forces of the thrust-time curve under the specified underwater working condition as the thrust forces, obtain the resistance forces at the various moments according to the velocity-resistance fitting curves of the multi-jointed bionic dolphin at the various moments, and subtract the resistance forces from the thrust forces to obtain combined forces of various joints of the multi-jointed bionic dolphin at the various moments by calculating.

A dolphin displacement and velocity calculation unit configured to substitute the combined force of the various joints of the multi-jointed bionic dolphin at the various moments into the kinetic model, and obtain the torques, as well as the displacements, the velocities, and the accelerations, along a direction of forward movement of the various joints of the multi-jointed bionic dolphin at the various moments by calculating to return to the step in which the resistance forces at the various moments are obtained according to the velocity-resistance fitting curve of the multi-jointed bionic dolphin at the various moments.

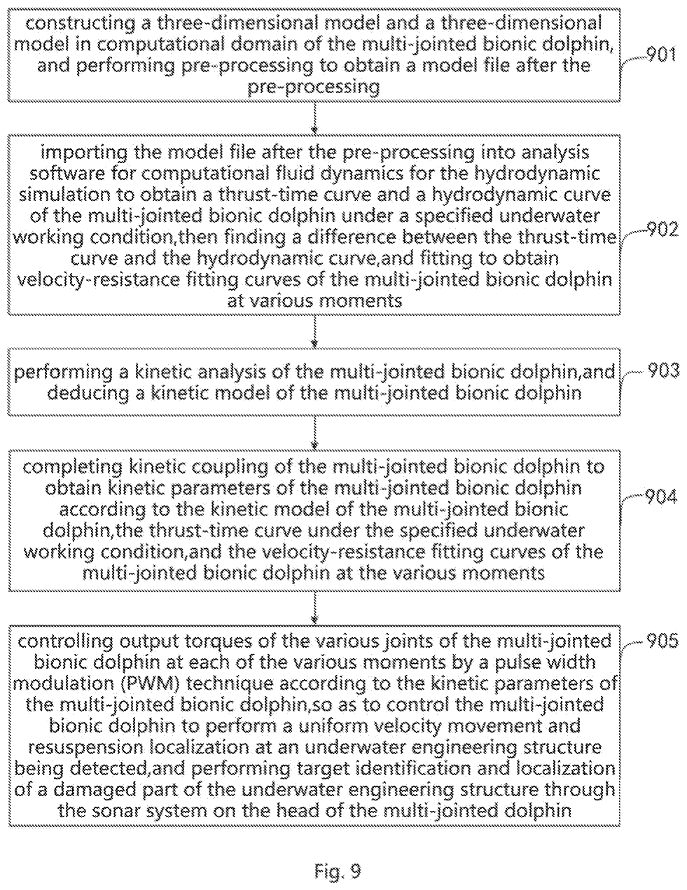

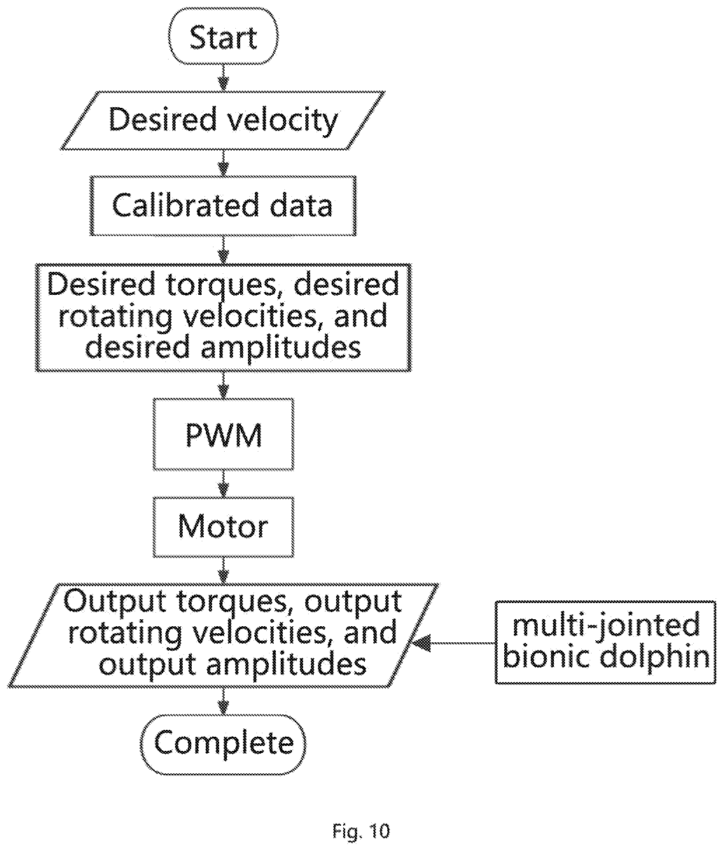

Based on the method of the present disclosure, the present disclosure also provides a method for detecting underwater damage detection based on motion control of the multi-jointed bionic dolphin. As shown in FIG. 9, the method for detecting underwater damage comprises:
Step 901: constructing a three-dimensional model and a three-dimensional model in computational domain of the multi-jointed bionic dolphin, and performing pre-processing to obtain a model file after the pre-processing; wherein a head of the multi-jointed bionic dolphin comprises a sonar system, the three-dimensional model is used to simulate a motion mode of the multi-jointed bionic dolphin, and the three-dimensional model in the computational domain is used for hydrodynamic simulation of the multi-jointed bionic dolphin;
Step 902: importing the model file after the pre-processing into analysis software for computational fluid dynamics for the hydrodynamic simulation to obtain a thrust-time curve and a hydrodynamic curve of the multi-jointed bionic dolphin under a specified underwater working condition, then finding a difference between the thrust-time curve and the hydrodynamic curve, and fitting to obtain velocity-resistance fitting curves of the multi-jointed bionic dolphin at various moments; wherein the specified underwater working condition mainly comprises whether there is flowing in the water domain or not and velocity and direction of water flowing;
Step 903: performing a kinetic analysis of the multi-jointed bionic dolphin, and deducing a kinetic model of the multi-jointed bionic dolphin;
Step 904: completing kinetic coupling of the multi-jointed bionic dolphin obtain the kinetic parameters of the multi-jointed bionic dolphin according to the kinetic model of the multi-jointed bionic dolphin, the thrust-time curve under the specified underwater working condition, and the velocity-resistance fitting curves of the multi-jointed bionic dolphin at the various moments; wherein the kinetic parameters comprise torques as well as accelerations, velocities, and displacements of the various joints of the multi-jointed bionic dolphin at various moments; and
Step 905: controlling the output torques of the various joints of the multi-jointed bionic dolphin at each of the various moments by the PWM technique according to the kinetic parameters of the multi-jointed bionic dolphin, so as to control the multi-jointed bionic dolphin to perform a uniform velocity movement and resuspension localization at the underwater engineering structure being detected, and target identification and localization of a damaged part of the underwater engineering structure is performed through the sonar system on the head of the multi-jointed dolphin.

The present disclosure can achieve damage detection and localization marking of an underwater engineering structure through the method for the precise motion control of the multi-jointed bionic dolphin of the present disclosure by installing the sonar system to the head of the multi-jointed bionic dolphin.

Various embodiments in this specification is progressively described, each embodiment focuses on differences differing from other embodiments, and same and similar parts of the various embodiment can be referred from one another. With respect to the system disclosed in the embodiments, as the system corresponds to the method disclosed in the embodiments, a description of the system is relatively simple, and relevant parts between the method and the system refer to the description of the method.

In the specification, specific embodiments are used to describe the principle and the implementation of the present disclosure, and the above-mentioned embodiments merely help to understand the method of the present disclosure and a core idea thereof. At the same time, specific embodiments and the application scope of the present disclosure all change according to the idea of the present disclosure for person of skill in the art. Therefore, the content of the specification should not be understood as a limitation of the present disclosure.

What is claimed is:

1. A method for controlling a motion of a multi-jointed bionic dolphin, comprising:
constructing a three-dimensional model and a three-dimensional model in computational domain of the multi-jointed bionic dolphin, and performing pre-processing to obtain a model file after the pre-processing; wherein the three-dimensional model is used to simulate a motion mode of the multi-jointed bionic dolphin, and the three-dimensional model in the computational domain is used for hydrodynamic simulation of the multi-jointed bionic dolphin;
importing the model file after the pre-processing into analysis software for computational fluid dynamics for the hydrodynamic simulation to obtain a thrust-time curve and a hydrodynamic curve of the multi-jointed bionic dolphin under a specified underwater working condition, then finding a difference between the thrust-time curve and the hydrodynamic curve, and fitting to obtain velocity-resistance fitting curves of the multi-jointed bionic dolphin at various moments; wherein the specified underwater working condition comprises whether there is flowing in the water domain or not and velocity and direction of water flowing;
performing a kinetic analysis of the multi-jointed bionic dolphin, and deducing a kinetic model of the multi-jointed bionic dolphin;
completing kinetic coupling of the multi-jointed bionic dolphin to obtain kinetic parameters of the multi-jointed bionic dolphin according to the kinetic model of the multi-jointed bionic dolphin, the thrust-time curve under the specified underwater working condition, and the velocity-resistance fitting curves of the multi-jointed bionic dolphin at the various moments; wherein the kinetic parameters comprise torques as well as accelerations, velocities, and displacements of various joints of the multi-jointed bionic dolphin at the various moments; and
controlling output torques of the various joints of the multi-jointed bionic dolphin at each of the various moments by a pulse width modulation (PWM) technique according to the kinetic parameters of the multi-jointed bionic dolphin.

2. The method according to claim 1, wherein:
the constructing a three-dimensional model and a three-dimensional model in computational domain of the multi-jointed bionic dolphin, and performing pre-processing to obtain a model file after the pre-processing comprises:
constructing the three-dimensional model and the three-dimensional model in the computational domain of the multi-jointed bionic dolphin in three-dimensional drawing software; and
importing the three-dimensional model and the three-dimensional model in the computational domain of the multi-jointed bionic dolphin into first software to perform pre-processing of model simplification and surface mesh segmentation of the three-dimensional model and the three-dimensional model in the computational domain to obtain the model file after the pre-processing.

3. The method according to claim 1, wherein:
the importing the model file after the pre-processing into analysis software for computational fluid dynamics for the hydrodynamic simulation to obtain a thrust-time curve and a hydrodynamic curve of the multi-jointed bionic dolphin under a specified underwater working condition, then finding a difference between the thrust-time curve and the hydrodynamic curve, and fitting to obtain velocity-resistance fitting curves of the multi-jointed bionic dolphin at various moments comprises:
importing the model file after the pre-processing into the analysis software for the computational fluid dynamics to complete construction of the computational domain, generating a body mesh, defining a boundary, and defining operation of deformation motion of the multi-jointed bionic dolphin;
setting water velocity in the computational domain to be zero, swinging a tail of the multi-jointed bionic dolphin, and obtaining a calculated thrust-time curve by calculating to function as the thrust-time curve of the multi-jointed bionic dolphin in the specified underwater working condition when the multi-jointed bionic dolphin is swinging according to a preset kinetic equation;
synthesizing velocities of linear motions of the multi-jointed bionic dolphin under the specified underwater working condition according to a principle of relative motion to obtain a synthesized velocity, converting the synthesized velocity into flowing of the water flowing for the hydrodynamic simulation, gradually increasing the velocity of the water flowing until a theoretical propulsion velocity of the multi-jointed bionic dolphin under thrust forces is obtained, and obtaining hydrodynamic curves of the multi-jointed bionic dolphin under the specified underwater working condition under different motion velocities in an accelerated motion; and
finding a difference based on the thrust-time curve and the hydrodynamic curves, and fitting to obtain a resistance curve varying with velocities at the various moments to function as the velocity-resistance fitting curve of the multi-jointed bionic dolphin at the various moments when the multi-jointed bionic dolphin swings according to the preset kinetic equation.

4. The method according to claim 1, wherein:
the performing a kinetic analysis of the multi-jointed bionic dolphin, and deducing a kinetic model of the multi-jointed bionic dolphin comprises:
performing the kinetic analysis of the multi-jointed bionic dolphin by a Lagrangian method to centralize hydrodynamic forces, transforming the kinetic analysis of the multi-jointed bionic dolphin into a multi-rigid-body system kinetic analysis, and deducing the kinetic model of the multi-jointed bionic dolphin.

5. The method according to claim 1, wherein:
the completing kinetic coupling of the multi-jointed bionic dolphin to obtain kinetic parameters of the multi-jointed bionic dolphin according to the kinetic model of the multi-jointed bionic dolphin, the thrust-time curve under the specified underwater working condition, and the velocity-resistance fitting curves of the multi-jointed bionic dolphin at the various moments comprises:
constructing the kinetic model of the multi-jointed bionic dolphin in second software, and setting mass and length parameters in the kinetic model of the multi-jointed bionic dolphin;
decomposing forces in the kinetic model into resistance forces and the thrust forces, defining corresponding thrust forces of the thrust-time curve under the specified underwater working condition as the thrust forces, obtaining the resistance forces at the various moments according to the velocity-resistance fitting curves of the multi-jointed bionic dolphin at the various moments, and subtract the resistance forces from the thrust forces to obtain combined forces of the various joints of the multi-jointed bionic dolphin at the various moments by calculating; and
substituting the combined forces of the various joints of the multi-jointed bionic dolphin at the various moments into the kinetic model, obtaining the torques as well as the displacements, the velocities, and the accelerations of the various joints of the multi-jointed bionic dolphin at the various moments along a direction of forward movement by calculating to return to the step in which the resistance forces at the various moments are obtained according to the velocity-resistance fitting curves of the multi-jointed bionic dolphin at the various moments.

6. A system for controlling a motion of a multi-jointed bionic dolphin, comprising:
a module for constructing a three-dimensional model and pre-processing, wherein the module for constructing the three-dimensional model and pre-processing is configured to construct the three-dimensional model and a three-dimensional model in a computational domain of the multi-jointed bionic dolphin and perform pre-processing to obtain a model file after the pre-processing; wherein the three-dimensional model is used to simulate a motion mode of the multi-jointed bionic dolphin, and the three-dimensional model in the computational domain is used for hydrodynamic simulation of the multi-jointed bionic dolphin;
a hydrodynamic simulation module, wherein the hydrodynamic simulation module is configured to import the model file after the pre-processing into analysis software for computational fluid dynamics for the hydrodynamic simulation to obtain a thrust-time curve and a hydrodynamic curve of the multi-jointed bionic dolphin under a specified underwater working condition, then find a difference between the thrust-time curve and the hydrodynamic curve, and fit to obtain velocity-resistance fitting curves of the multi-jointed bionic dolphin at various moments; wherein the specified underwater working condition comprises whether there is flowing in a water domain or not and velocity and direction of water flowing;
a kinetic analysis module for performing a kinetic analysis of the multi-jointed bionic dolphin and deducing a kinetic model of the multi-jointed bionic dolphin;
a kinetic coupling module for completing kinetic coupling of the multi-jointed bionic dolphin obtain kinetic parameters of the multi-jointed bionic dolphin according to the kinetic model of the multi-jointed bionic dolphin, the thrust-time curve under the specified underwater working condition, and the velocity-resistance fitting curves of the multi-jointed bionic dolphin at the various moments; wherein the kinetic parameters comprise torques as well as accelerations, velocities, and displacements of the various joints of the multi-jointed bionic dolphin at the various moments; and
a dolphin motion control module for controlling output torques of the various joints of the multi-jointed bionic dolphin at each of the various moments by the pulse width modulation (PWM) technique according to the kinetic parameters of the multi-jointed bionic dolphin.

7. The system according to claim 6, wherein:
the module for constructing the three-dimensional model and pre-processing comprises:
a three-dimensional model constructing unit configured to construct the three-dimensional model and the three-dimensional model in the computational domain of the multi-jointed bionic dolphin in three-dimensional drawing software; and
a pre-processing unit configured to import the three-dimensional model and the three-dimensional model into the computational domain of the multi-jointed bionic dolphin into first software to perform pre-processing of model simplification and surface mesh segmentation of the three-dimensional model and the three-dimensional model in the computational domain to obtain the model file after the pre-processing.

8. The system according to claim 6, wherein:
the hydrodynamic simulation module comprises:
a model file import unit configured to import the model file after the pre-processing into the analysis software for computational fluid dynamics to complete construction of the computational domain, generate a body mesh, define a boundary, and define operation of deformation motion of the multi-jointed bionic dolphin;
a thrust curve calculation unit configured to set water velocity in the computational domain to be zero, swing a tail of the multi-jointed bionic dolphin, and obtain a calculated thrust-time curve by calculating to function as the thrust-time curve of the multi-jointed bionic dolphin in the specified underwater working condition when the multi-jointed bionic dolphin is swinging according to a preset kinetic equation;
a hydrodynamic curve calculation unit configured to synthesize velocities of linear motions of the multi-jointed bionic dolphin under the specified underwater working condition according to a principle of relative motion to obtain synthesized velocity, convert the synthesized velocity into flowing of the water flowing for the hydrodynamic simulation, gradually increase a velocity of the water flowing until a theoretical propulsion velocity of the multi-jointed bionic dolphin under the thrust forces is obtained, and obtaining hydrodynamic curves of the multi-jointed bionic dolphin under the specified underwater working condition under different motion velocities in an accelerated motion; and
a velocity-resistance fitting curve calculation unit configured to find a difference based on the thrust-time curve and the hydrodynamic curves and fit to obtain a resistance curve varying with velocities at the various moments to function as the velocity-resistance fitting curve of the multi-jointed bionic dolphin at the various moments when the multi-jointed bionic dolphin swings according to the preset kinetic equation.

9. The system according to claim 6, wherein:
the kinetic analysis module comprises:
a kinetic analysis unit configure to perform the kinetic analysis of the multi-jointed bionic dolphin by a Lagrangian method to centralize hydrodynamic forces, transform the kinetic analysis of the multi-jointed bionic dolphin into a multi-rigid-body system kinetic analysis, and deduce the kinetic model of the multi-jointed bionic dolphin.

10. A method for detecting underwater damage based on motion control of a multi-jointed bionic dolphin, comprising:
constructing a three-dimensional model and a three-dimensional model in computational domain of the multi-jointed bionic dolphin, and performing pre-processing to obtain a model file after the pre-processing; wherein a head of the multi-jointed bionic dolphin comprises a sonar system, the three-dimensional model is used to simulate a motion mode of the multi-jointed bionic dolphin, and the three-dimensional model in the computational domain is used for hydrodynamic simulation of the multi-jointed bionic dolphin;
importing the model file after the pre-processing into analysis software for computational fluid dynamics for the hydrodynamic simulation to obtain a thrust-time curve and a hydrodynamic curve of the multi-jointed bionic dolphin under a specified underwater working condition, then finding a difference between the thrust-time curve and the hydrodynamic curve, and fitting to obtain velocity-resistance fitting curves of the multi-jointed bionic dolphin at various moments; wherein the specified underwater working condition comprises whether there is flowing in a water domain or not and velocity and direction of the water flowing;
performing a kinetic analysis of the multi-jointed bionic dolphin, and deducing a kinetic model of the multi-jointed bionic dolphin;
completing kinetic coupling of the multi-jointed bionic dolphin to obtain kinetic parameters of the multi-jointed bionic dolphin according to the kinetic model of the multi-jointed bionic dolphin, the thrust-time curve under the specified underwater working condition, and the velocity-resistance fitting curves of the multi-jointed bionic dolphin at the various moments; wherein the kinetic parameters comprise torques as well as accelerations, velocities, and displacements of the various joints of the multi-jointed bionic dolphin at the various moments; and
controlling output torques of the various joints of the multi-jointed bionic dolphin at each of the various moments by a pulse width modulation (PWM) technique according to the kinetic parameters of the multi-jointed bionic dolphin, so as to control the multi-jointed bionic dolphin to perform a uniform velocity movement and resuspension localization at an underwater engineering structure being detected, and performing target identification and localization of a damaged part of the underwater engineering structure through the sonar system on the head of the multi-jointed dolphin.

11. The method according to claim 1, wherein:
the controlling the torques of the various joints of the multi-jointed bionic dolphin at each of the various moments by a PWM technique according to the kinetic parameters of the multi-jointed bionic dolphin comprises:
calibrating a velocity of the multi-joint bionic dolphin and the torques, rotating velocities, and amplitudes of the various joints of the multi-joint bionic dolphin to obtain calibration data based on the hydrodynamic simulation of the multi-jointed bionic dolphin.

12. The method according to claim 11, wherein:
the controlling the torques of the various joints of the multi-jointed bionic dolphin at each of the various moments by a PWM technique according to the kinetic parameters of the multi-jointed bionic dolphin comprises:
obtaining a specified velocity of the multi-joint bionic dolphin according to an instruction, finding specified torques, specified rotating velocities, specified amplitudes of the joints of the multi-joint bionic dolphin corresponding to the specified velocity from the calibration data, modulating the specified torques, the specified rotating velocities, and the specified amplitudes into electrical signals required by a motor by the PWM technique, adjusting output torques, output rotating velocities, output amplitudes of the joints of the multi-joint bionic dolphin after the motor receives the electrical signals, achieving the specified velocity of the multi-joint bionic dolphin through cooperation with multi-joint motors.

13. The method according to claim 10, further comprising:
the controlling the torques of the various joints of the multi-jointed bionic dolphin at each of the various moments by a PWM technique according to the kinetic parameters of the multi-jointed bionic dolphin comprises:
calibrating a velocity of the multi-joint bionic dolphin and the torques, rotating velocities, and amplitudes of the various joints of the multi-joint bionic dolphin to obtain calibration data based on the hydrodynamic simulation of the multi-jointed bionic dolphin.

14. The method according to claim 13, wherein:
the controlling the torques of the various joints of the multi-jointed bionic dolphin at each of the various moments by a PWM technique according to the kinetic parameters of the multi-jointed bionic dolphin comprises:
obtaining a specified velocity of the multi-joint bionic dolphin according to an instruction, finding specified torques, specified velocities, specified amplitudes of the joints of the multi-joint bionic dolphin corresponding to the specified velocity from calibration data, modulating the specified torques, the specified velocities, and the specified amplitudes into electrical signals required by a motor by the PWM technique, adjusting output torques, output rotating velocities, output amplitudes of the joints of the multi-joint bionic dolphin after the motor receives the electrical signals, achieving the specified velocity of the multi-joint bionic dolphin through cooperation with multi-joint motors.

15. The system according to claim 6, wherein:
the dolphin motion control module is configured to:
calibrate a velocity of the multi-joint bionic dolphin and the torques, rotating velocities, and amplitudes of the various joints of the multi-joint bionic dolphin to obtain calibration data based on the hydrodynamic simulation of the multi-jointed bionic dolphin.

16. The method according to claim 15, wherein:
the dolphin motion control module is configured to:
control the torques of the various joints of the multi-jointed bionic dolphin at each of the various moments by the PWM technique according to the kinetic parameters of the multi-jointed bionic dolphin by obtaining a specified velocity of the multi-joint bionic dolphin according to an instruction, finding specified torques, specified velocities, specified amplitudes of the joints of the multi-joint bionic dolphin corresponding to the specified velocity from calibration data, modulating the specified torques, the specified velocities, and the specified amplitudes into electrical signals required by a motor by the PWM technique, adjusting output torques, output rotating velocities, output amplitudes of the joints of the multi-joint bionic dolphin after the motor receives the electrical signals, achieving the specified velocity of the multi-joint bionic dolphin through cooperation with multi-joint motors.
